(19) United States
(12) Patent Application Publication
(10) Pub. No.: US 2022/0150464 A1
(43) Pub. Date: May 12, 2022

(54) IMAGE PROCESSING APPARATUS, IMAGE PROCESSING METHOD, AND IMAGE PROCESSING PROGRAM

(71) Applicant: SONY GROUP CORPORATION, TOKYO (JP)

(72) Inventors: NAOTAKA OJIRO, TOKYO (JP); RYOHEI TAKAHASHI, TOKYO (JP); TOSHIYA HAMADA, TOKYO (JP); MITSUHIRO HIRABAYASHI, TOKYO (JP)

(21) Appl. No.: 17/434,182

(22) PCT Filed: Feb. 26, 2020
(86) PCT No.: PCT/JP2020/007850

§ 371 Date: Aug. 26, 2021

(30) Foreign Application Priority Data
Mar. 8, 2019 (JP) 2019-043201

(51) Int. Cl. H04N 13/282; H04N 13/279; H04N 13/139

(52) U.S. Cl. CPC H04N 13/282; H04N 13/139; H04N 13/279

(57) ABSTRACT

An image processing apparatus according to the present disclosure includes: an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and a generation unit that generates transition field-of-view information, which is information indicating the transition in field of view from the first field of view to the second field of view on the basis of the first field-of-view information and the second field-of-view information.

### TECHNICAL FIELD

The present disclosure relates to an image processing apparatus, an image processing method, and an image processing program. Specifically, the present disclosure relates to image processing for providing a seamless screen transition that gives less feeling of strangeness in a wide angle-of-view video.

### BACKGROUND ART

Images (hereinafter collectively referred to as “wide angle-of-view images”) having an angle of view wider than an angle of view displayed on a display, such as omnidirectional content or a panoramic image, are widely used. In general, a full angle of view of a wide angle-of-view image cannot be displayed on a display apparatus at the same time, and thus a part of a video is cropped and displayed.

A wide variety of technologies have been proposed for displaying such a wide angle-of-view image. For example, a technique for passive viewing has been proposed for viewing while a field of view of a video to be reproduced and displayed is automatically changed in chronological order on the basis of recommended field-of-view information (region of interest (ROI)) provided by a content creator.

### CITATION LIST

### Non-Patent Document

Non-Patent Document 1: ISO/IEC FDIS 23090-2 (2018.4.26, w17563) [MPEG-I Part-2: OMAF]

### SUMMARY OF THE INVENTION

### Problems to be Solved by the Invention

According to a conventional technology, a user can view a wide angle-of-view image as if the user is moving a line of sight in accordance with recommended field-of-view information provided together with content, without any need for an operation.

However, in the above-described conventional technology, it is not always possible to improve user experience related to a wide angle-of-view image. For example, at the time of moving image reproduction of a wide angle-of-view image, it is assumed not only that passive viewing in which an image is displayed in accordance with recommended field-of-view information is performed, but also that active viewing in which a user selects a position (field of view) to be viewed in the image is performed. In a case where it is possible to switch between the two types of viewing styles at an optional timing, a video of a field of view becomes chronologically discontinuous between the video of the field of view in the active viewing and information of the field of view in the passive viewing. Thus, there is a possibility that the user loses a sense of direction in the viewing, and gets a feeling of strangeness. As a result, there is a possibility that a sense of immersion in the wide angle-of-view image is ruined.

Thus, the present disclosure proposes an image processing apparatus, an image processing method, and an image processing program capable of improving user experience related to a wide angle-of-view image.

### Solutions to Problems

In order to solve the problem described above, an aspect according to the present disclosure provides an image processing apparatus including: an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and a generation unit that generates transition field-of-view information, which is information indicating the transition in field of view from the first field of view to the second field of view on the basis of the first field-of-view information and the second field-of-view information.

### BRIEF DESCRIPTION OF DRAWINGS

FIG. 1 is a diagram for illustrating omnidirectional content.

FIG. 2 is a diagram for illustrating a line-of-sight movement in the omnidirectional content.

FIG. 3 is a diagram for illustrating a field-of-view area in the omnidirectional content.

FIG. 4 is a diagram for illustrating recommended field-of-view information in the omnidirectional content.

FIG. 5 is a diagram illustrating a configuration example of an image processing apparatus according to a first embodiment.

FIG. 6 is a diagram for illustrating processing of acquiring field-of-view information according to the first embodiment.

FIG. 7 is a diagram for illustrating generation processing according to the first embodiment.

FIG. 8 is a diagram conceptually illustrating transition field-of-view information according to the first embodiment.

FIG. 9 is a diagram (1) illustrating an example of video display according to the first embodiment.

FIG. 10 is a diagram (2) illustrating an example of video display according to the first embodiment.

FIG. 11 is a flowchart (1) illustrating a flow of processing according to the first embodiment.

FIG. 12 is a flowchart (2) illustrating a flow of processing according to the first embodiment.

FIG. 13 is a flowchart (3) illustrating a flow of processing according to the first embodiment.

FIG. 14 is a diagram conceptually illustrating missing of recommended field-of-view metadata.

FIG. 15 is a diagram (1) illustrating an example of image processing according to a modified example of the first embodiment.

FIG. 16 is a diagram (2) illustrating an example of image processing according to a modified example of the first embodiment.

FIG. 17 is a diagram illustrating an example of processing of generating a complementary image.

FIG. 18 is a diagram illustrating an example of image processing according to a second embodiment.

FIG. 19 is a diagram for illustrating an example of the image processing according to the second embodiment.

FIG. 20 is a flowchart illustrating a flow of processing according to the second embodiment.

FIG. 21 is a hardware configuration diagram illustrating an example of a computer that implements functions of the image processing apparatus.

### MODE FOR CARRYING OUT THE INVENTION

Hereinafter, embodiments of the present disclosure will be described in detail with reference to the drawings. Note that, in the following embodiments, the same portions are denoted by the same reference numerals, and duplicate description will be omitted.

The present disclosure will be described in the order of items described below.

### 1. First Embodiment

1-1. Image processing related to wide angle-of-view image

1-2. Configuration of image processing apparatus according to first embodiment

1-3. Procedure of information processing according to first embodiment

1-4. Modified examples according to first embodiment

2. Second Embodiment

3. Other embodiments

4. Effects of image processing apparatus according to present disclosure

5. Hardware configuration

### 1. First Embodiment

[1-1. Image Processing Related to Wide Angle-of-View Image]

Prior to description of image processing according to the present disclosure, a method of display processing of a wide angle-of-view image, which is a premise of the image processing of the present disclosure, will be described.

Note that a wide angle-of-view image according to the present disclosure is an image having an angle of view wider than the angle of view displayed on a display, such as omnidirectional content or a panoramic image. In the present disclosure, omnidirectional content will be described as an example of the wide angle-of-view image.

Omnidirectional content is generated by imaging with an omnidirectional camera capable of imaging 360 degrees in all directions, for example. Since the omnidirectional content has a wider angle of view than a common display (e.g., a liquid crystal display or a head mounted display (HMD) worn by a user), only a partial area trimmed in accordance with the size of the display (in other words, a viewing angle of the user) is displayed when the omnidirectional content is reproduced. For example, the user views the omnidirectional content while changing a display position by operating a touch display to change a displayed portion, or by giving a change in line of sight or posture via the HMD the user is wearing.

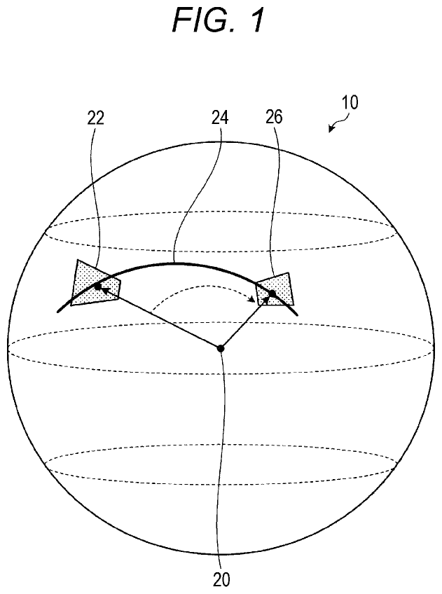

Viewing of omnidirectional content will be specifically described with reference to FIG. 1. FIG. 1 is a diagram for illustrating omnidirectional content. FIG. 1 illustrates omnidirectional content 10, which is an example of a wide angle-of-view image.

Specifically, FIG. 1 conceptually illustrates a positional relationship when a user views the omnidirectional content 10. In the example illustrated in FIG. 1, the user is at a center 20 of the omnidirectional content 10, and views a part of the omnidirectional content 10.

In a case where the user actively views the omnidirectional content 10, the user changes a field of view with respect to the omnidirectional content 10 by, for example, changing an orientation of the HMD the user is wearing, or executing an operation of moving a video displayed on a display.

Note that the field of view in the present disclosure indicates a range viewed by the user in the wide angle-of-view image. The field of view of the user is specified by field-of-view information, which is information for specifying the field of view. The field-of-view information may be in any form as long as the field-of-view information can specify the field of view of the user. For example, the field-of-view information is a user's line-of-sight direction in the wide angle-of-view image, and a display angle of view (that is, a field-of-view area) in the wide angle-of-view image. Furthermore, the field-of-view information may be indicated by coordinates or a vector from the center of the wide angle-of-view image.

The user views, for example, a video corresponding to a field-of-view area 22, which is a part of the omnidirectional content 10, by directing the line of sight in a predetermined direction from the center 20. Furthermore, the user moves the line of sight through a moving path indicated by a curve 24 to view a video corresponding to a field-of-view area 26. In this manner, in the omnidirectional content 10, the user can actively move the line of sight to view videos corresponding to a variety of angles.

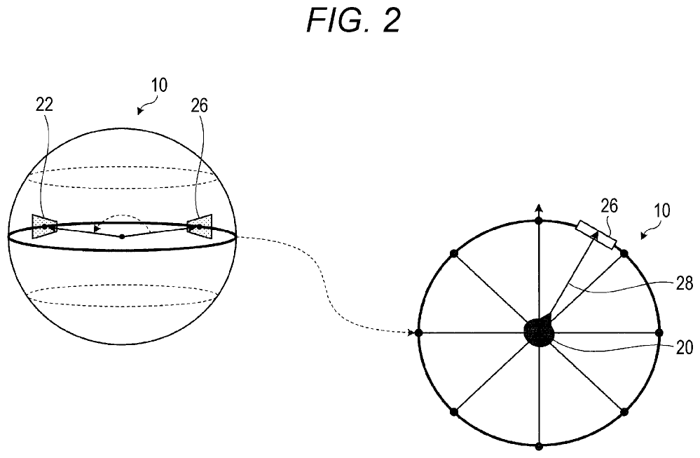

Next, the example illustrated in FIG. 1 will be described from another angle with reference to FIG. 2. FIG. 2 is a diagram for illustrating a line-of-sight movement in the omnidirectional content 10.

FIG. 2 illustrates the line of sight of the user in a case where the omnidirectional content 10 illustrated in FIG. 1 is viewed downward from the zenith. For example, in a case where the user views the video corresponding to the field-of-view area 22 and then tries to view the video corresponding to the field-of-view area 26, the user can view the video corresponding to the field-of-view area 26 by turning in the direction of a vector 28.

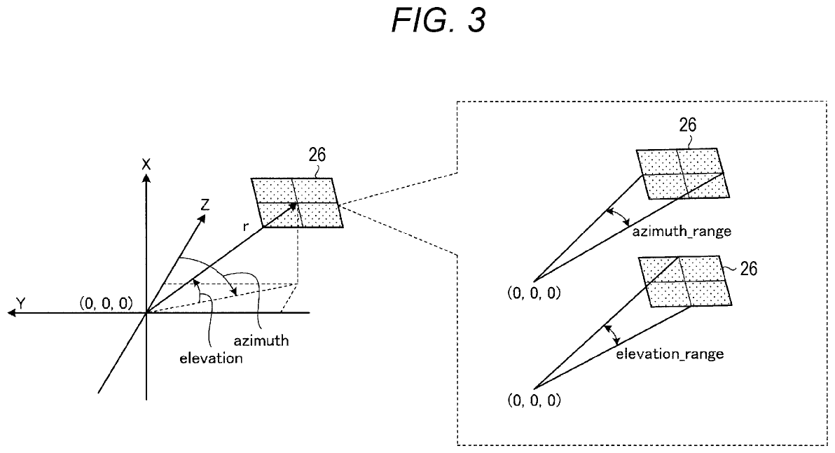

Furthermore, a field-of-view area in the omnidirectional content 10 will be described with reference to FIG. 3. FIG. 3 is a diagram for illustrating a field-of-view area in the omnidirectional content.

In FIG. 3, the field-of-view area 26 illustrated in FIGS. 1 and 2 is conceptually illustrated using an x axis, a y axis, and a z axis. As illustrated in FIG. 3, the field-of-view area 26 is specified on the basis of an angle from the y axis to the x axis (commonly referred to as an elevation) or an angle from the z axis to the y axis (commonly referred to as an azimuth). Furthermore, as illustrated in FIG. 3, the field-of-view area 26 is specified on the basis of an angle of view on the azimuth side (azimuth_range), an angle of view on the elevation angle side (elevation_range), or the like. In the present disclosure, these pieces of information for specifying the field-of-view area 26 are referred to as field-of-view information corresponding to the field-of-view area 26. Note that the information for specifying the field-of-view area is not limited to the examples illustrated in FIG. 3, and may be any information as long as the information can specify the line-of-sight direction and the range of the area (angle of view). For example, a variable (parameter) indicating the field-of-view information may indicate the line-of-sight direction with reference to the center by numerical values of yaw, pitch, and roll.

As described above, in a case of a wide angle-of-view image such as the omnidirectional content 10, for example, in viewing on the HMD, the user swings the user's head to change an orientation of the head, or in viewing on a flat display, the line-of-sight direction is changed by a cursor operation on a remote controller or the like, and thus the video in an optional direction is cropped. That is, the omnidirectional content 10 achieves video expression as if the line of sight transitions in the vertical direction or the horizontal direction (pan or tilt) in accordance with a user operation.

FIGS. 1 to 3 illustrate an example in which the user actively changes the line of sight. However, a line-of-sight direction recommended by a content creator may be registered in advance in content. Such information is referred to as recommended field-of-view information (region of interest (ROI)). Note that, in the present disclosure, recommended field-of-view information embedded in content is referred to as recommended field-of-view metadata.

For example, in a case where the omnidirectional content 10 is moving image content, recommended field-of-view metadata for specifying a field-of-view area viewed by a user may be registered in the content along a time axis. In this case, the user can experience video expression in which the line of sight automatically moves in accordance with an intention of a content creator, without the user changing the line of sight.

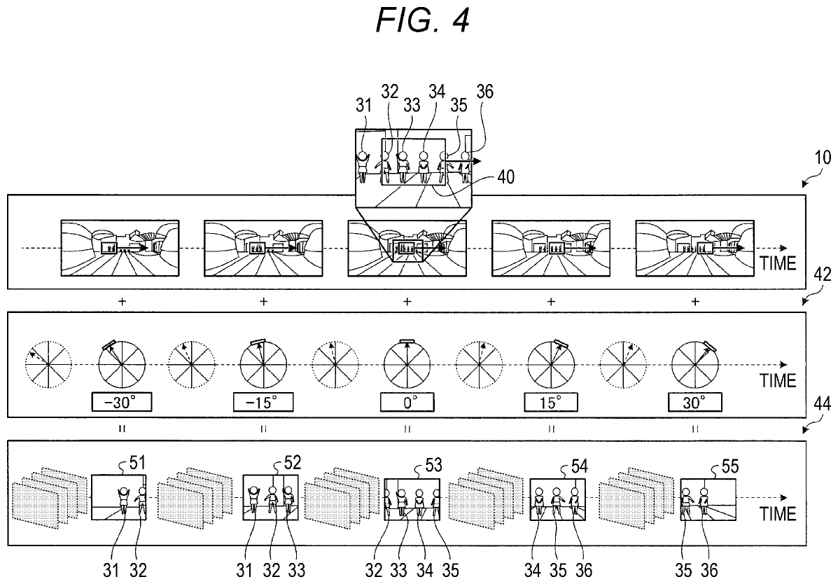

This point will be described with reference to FIG. 4. FIG. 4 is a diagram for illustrating recommended field-of-view information in the omnidirectional content 10.

FIG. 4 illustrates, in chronological order, an image showing the omnidirectional content 10 by equidistant cylindrical projection, an angle of view 42 corresponding to the image, and a video set 44 that a user actually views.

In the example in FIG. 4, the omnidirectional content 10 contains an area where an object 31, an object 32, an object 33, an object 34, an object 35, and an object 36 are displayed. In the omnidirectional content 10, not all angles of view are displayed at a time, and thus some of these objects are displayed in accordance with the angle of view. For example, as illustrated in FIG. 4, in a field-of-view area 40 corresponding to an azimuth of 0°, the objects 32 to 35 are displayed.

Furthermore, it is assumed that the omnidirectional content 10 illustrated in FIG. 4 contains recommended field-of-view metadata that sequentially displays the objects 31 to 36 in chronological order.

In this case, when the omnidirectional content 10 is reproduced, the user can view the moving image in accordance with the recommended field-of-view metadata without moving the user's line of sight. For example, in the example in FIG. 4, the user views from an azimuth of −30° to an azimuth of 30° as a continuous video (moving image).

Specifically, the user views, at the azimuth of −30°, a video 51 in which the object 31 and the object 32 are displayed. Next, the user views, at an azimuth of −15°, a video 52 in which the object 31, the object 32, and the object 33 are displayed. Next, the user views, at an azimuth of 0°, a video 53 in which the objects 32 to 35 are displayed. Next, the user views, at an azimuth of 15°, a video 55 in which the object 34, the object 35, and the object 36 are displayed. Finally, the user views, at the azimuth of 30°, the video 55 in which the object 35 and the object 36 are displayed.

In this manner, the user can view the omnidirectional content 10 in chronological order in accordance with the intention of the content creator. As described with reference to FIGS. 1 to 4, in the omnidirectional content 10, there are active viewing in which the user actively changes the line-of-sight and passive viewing in accordance with the recommended field-of-view information. Then, some pieces of content allow for switching between the two types of viewing styles at an optional timing. Examples of such content include content in which, although a user can optionally move the line of sight while the moving image is being reproduced, a particular angle to be viewed at a certain time has been set, and content in which a transition to recommended field-of-view information (returning to a viewpoint in accordance with metadata registered in advance) is performed after a predetermined time since the user has stopped actively performing an operation.

In such content, a video of a field of view becomes chronologically discontinuous between the video of the field of view in active viewing and information of the field of view in passive viewing. Thus, there is a possibility that the user loses a sense of direction in the viewing, and gets a feeling of strangeness. That is, technologies related to wide angle-of-view images are facing a challenge of achieving a seamless transition of video display between different viewing styles.

Thus, the image processing according to the present disclosure allows for a seamless transition of video display between different viewing styles by using the means described below. Specifically, an image processing apparatus 100 according to the present disclosure acquires first field-of-view information, which is information for specifying a first field of view of a user in a wide angle-of-view image, and second field-of-view information, which is information for specifying a second field of view, which is a field of view at a destination of a transition from the first viewing field of view. Then, on the basis of the acquired first field-of-view information and second field-of-view information, the image processing apparatus 100 generates transition field-of-view information, which is information indicating the transition in field of view from the first field of view to the second field of view.

Specifically, the image processing apparatus 100 acquires field-of-view information regarding a field of view (first field of view) that the user has been actively viewing and field-of-view information regarding a field of view (second field of view) that is expected to be displayed after a predetermined time on the basis of recommended field-of-view information, and generates information for a smooth transition between the fields of view (in other words, a moving path for the field of view to move). This allows the user to avoid experiencing switching of the field of view due to an abrupt movement of the line of sight, and accept the switching of the line of sight without getting a feeling of strangeness. That is, the image processing apparatus 100 is capable of improving user experience related to a wide angle-of-view image. Hereinafter, image processing according to the present disclosure will be described in detail.

[1-2. Configuration of Image Processing Apparatus According to First Embodiment]

The image processing apparatus 100 according to the present disclosure is a so-called client that acquires and reproduces a wide angle-of-view image from an external data server or the like. That is, the image processing apparatus 100 is a reproduction device for reproducing a wide angle-of-view image. The image processing apparatus 100 may be an HMD, or may be an information processing terminal such as a personal computer, a tablet terminal, or a smartphone.

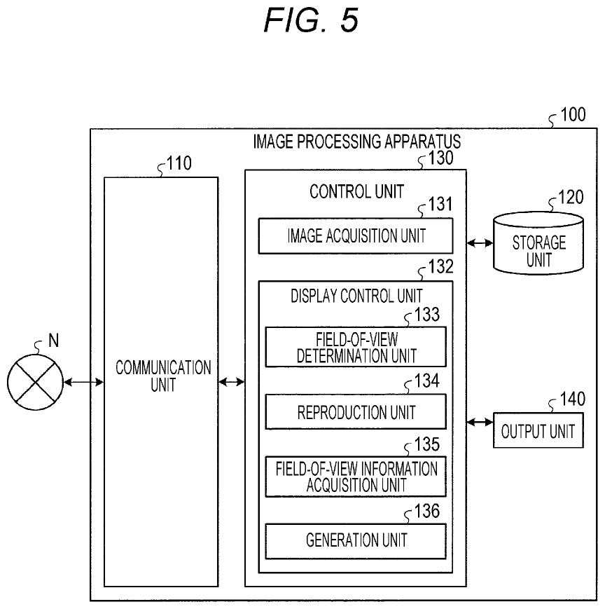

A configuration of the image processing apparatus 100 that implements the image processing according to the present disclosure will be described with reference to FIG. 5. FIG. 5 is a diagram illustrating a configuration example of the image processing apparatus 100 according to a first embodiment.

As illustrated in FIG. 5, the image processing apparatus 100 includes a communication unit 110, a storage unit 120, a control unit 130, and an output unit 140. Note that the image processing apparatus 100 may include an input unit (e.g., a keyboard or a mouse) that accepts various operations from a user or the like who operates the image processing apparatus 100.

The communication unit 110 is constituted by, for example, a network interface card (NIC). The communication unit 110 is connected to a network N (the Internet or the like) in a wired or wireless manner, and transmits and receives information to and from an external data server or the like that provides a wide angle-of-view image or the like via the network N.

The storage unit 120 is constituted by, for example, a semiconductor memory element such as a random access memory (RAM) or a flash memory, or a storage device such as a hard disk or an optical disk. The storage unit 120 stores, for example, content data such as an acquired wide angle-of-view image.

The control unit 130 is implemented by, for example, a central processing unit (CPU), a micro processing unit (MPU), a graphics processing unit (GPU), or the like executing a program (e.g., an image processing program according to the present disclosure) stored in the image processing apparatus 100 by using a random access memory (RAM) or the like as a working area. Furthermore, the control unit 130 is a controller, and may be constituted by, for example, an integrated circuit such as an application specific integrated circuit (ASIC) or a field programmable gate array (FPGA).

As illustrated in FIG. 5, the control unit 130 includes an image acquisition unit 131 and a display control unit 132, and implements or executes a function or an action of information processing described below. Note that an internal configuration of the control unit 130 is not limited to the configuration illustrated in FIG. 5, and may be any other configuration as long as the configuration performs information processing described later.

The image acquisition unit 131 acquires various types of information via a wired or wireless network or the like. For example, the image acquisition unit 131 acquires a wide angle-of-view image from an external data server or the like.

The display control unit 132 controls display of the wide angle-of-view image acquired by the image acquisition unit 131 on the output unit 140 (that is, a video display screen). For example, the display control unit 132 decompresses data of the wide angle-of-view image, and extracts video data and audio data to be retrieved and reproduced in a timely way. Furthermore, the display control unit 132 extracts recommended field of view (ROI) metadata registered in advance in the wide angle-of-view image, and supplies the recommended field of view (ROI) metadata to a processing unit in a subsequent stage.

As illustrated in FIG. 5, the display control unit 132 includes a field-of-view determination unit 133, a reproduction unit 134, a field-of-view information acquisition unit 135, and a generation unit 136.

The field-of-view determination unit 133 determines a field of view for displaying a wide angle-of-view image. That is, the field-of-view determination unit 133 specifies a user's line-of-sight direction in the wide angle-of-view image. For example, the field-of-view determination unit 133 determines a position (field of view) of the wide angle-of-view image that is actually displayed on the output unit 140 on the basis of a view angle set by default for the wide angle-of-view image, recommended field-of-view metadata, a user operation, or the like.

For example, in a case where the image processing apparatus 100 is an HMD, the field-of-view determination unit 133 detects information regarding a motion of a user wearing the HMD, that is, so-called head tracking information. Specifically, the field-of-view determination unit 133 detects various types of information regarding a user motion such as an orientation, an inclination, a movement, and a moving speed of a user's body by controlling sensors included in the HMD. More specifically, the field-of-view determination unit 133 detects, as information regarding a user motion, information regarding the head or posture of the user, a movement (acceleration or angular velocity) of the head or body of the user, the direction of the field of view, the speed of a viewpoint movement, or the like. For example, the field-of-view determination unit 133 controls various motion sensors such as a three-axis acceleration sensor, a gyro sensor, and a speed sensor as sensors, and detects information regarding a user motion. Note that the sensors are not necessarily included inside the HMD, and may be, for example, external sensors connected to the HMD in a wired or wireless manner.

Furthermore, the field-of-view determination unit 133 detects the position of the viewpoint gazed by the user on a display of the HMD. The field-of-view determination unit 133 may use a wide variety of known techniques detect the viewpoint position. For example, the field-of-view determination unit 133 may use the above-described three-axis acceleration sensor, gyro sensor, or the like to estimate the orientation of the user's head, thereby detecting the user's viewpoint position. Furthermore, the field-of-view determination unit 133 may use a camera that images user's eyes as a sensor to detect the user's viewpoint position. For example, the sensor is installed at a position where eyeballs of the user are located within an imaging range when the user wears the HMD on the head (e.g., a position close to the display with a lens directed toward the user side). Then, the sensor recognizes the direction in which the line of sight of the right eye is directed on the basis of a captured image of the eyeball of the right eye of the user and a positional relationship with the right eye. In a similar manner, the sensor recognizes the direction in which the line of sight of the left eye is directed on the basis of a captured image of the eyeball of the left eye of the user and a positional relationship with the left eye. The field-of-view determination unit 133 may detect which position in the display the user is gazing at on the basis of such positions of the eyeballs.

Through the processing described above, the field-of-view determination unit 133 acquires information regarding an area, in the wide angle-of-view image, displayed on the display (field of view in the wide angle-of-view image). That is, the field-of-view determination unit 133 acquires information indicating an area designated by information regarding the user's head or posture or an area designated by a user's touch operation or the like, in the wide angle-of-view image. Furthermore, the field-of-view determination unit 133 may detect an angle-of-view setting for a partial image in the wide angle-of-view image displayed in the area. The angle-of-view setting is, for example, a setting of zoom magnification.

The reproduction unit 134 reproduces the wide angle-of-view image as video data. Specifically, on the basis of the field of view determined by the field-of-view determination unit 133, the reproduction unit 134 processes the wide angle-of-view image for display (e.g., crops an image in accordance with a designated line-of-sight direction and angle of view, and processes the image into a planar projection image). Then, the reproduction unit 134 renders the processed video data, and displays the video data on the output unit 140.

Furthermore, the reproduction unit 134 acquires recommended field-of-view metadata registered in the wide angle-of-view image, extracts recommended field-of-view information to be supplied in chronological order, and uses the recommended field-of-view information for rendering in a timely way. That is, the reproduction unit 134 functions as a renderer that determines a display area on the basis of the field of view determined by the field-of-view determination unit 133 and performs rendering (image generation). Specifically, the reproduction unit 134 performs rendering on the basis of a frame rate determined in advance (e.g., frame per second (fps)), and reproduces a video corresponding to the wide angle-of-view image.

The field-of-view information acquisition unit 135 acquires field-of-view information in the wide angle-of-view image being reproduced by the reproduction unit 134. For example, the field-of-view information acquisition unit 135 acquires first field-of-view information, which is information for specifying a first field of view of a user in a wide angle-of-view image. Specifically, on the basis of a user operation while the wide angle-of-view image is being reproduced, a position of the head and a line of sight of the user, and the like, the field-of-view information acquisition unit 135 acquires field-of-view information for specifying a field of view in which the user is viewing at the present time.

For example, the field-of-view information acquisition unit 135 acquires information regarding the field of view of the user in the omnidirectional content 10, which is an example of the wide angle-of-view image. That is, the field-of-view information acquisition unit 135 acquires, as the first field-of-view information, field-of-view information corresponding to an area in which the user views the omnidirectional content 10 from the center of the omnidirectional content 10.

Furthermore, the field-of-view information acquisition unit 135 acquires second field-of-view information, which is information for specifying a second field of view, which is a field of view at a destination of a transition from the first field of view. For example, the field-of-view information acquisition unit 135 acquires the second field-of-view information of the second field of view to which the transition from the first field of view after a predetermined time is predicted on the basis of recommended field-of-view information, which is information indicating a line-of-sight movement registered in advance in the wide angle-of-view image.

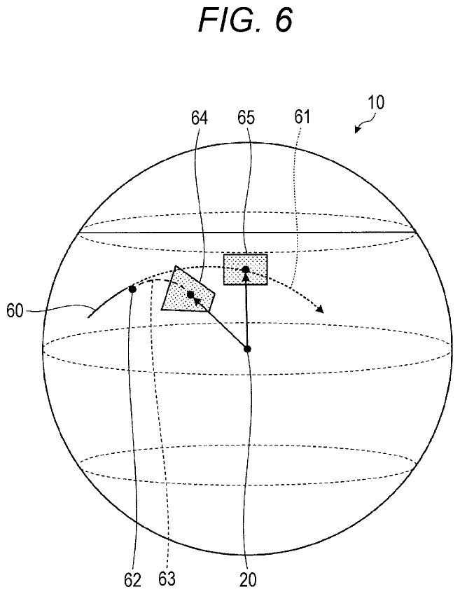

This point will be described with reference to FIG. 6. FIG. 6 is a diagram for illustrating processing of acquiring field-of-view information according to the first embodiment.

In the example illustrated in FIG. 6, a user is located at the center 20 and views the omnidirectional content 10. At this time, it is assumed that information regarding a line of sight moving in chronological order (information regarding a moving path, a view angle, and the like) is registered in the omnidirectional content 10 as recommended field-of-view metadata. In the example in FIG. 6, a moving path 60 is registered in the omnidirectional content 10 as recommended field-of-view metadata. In this case, in a case where the user does not perform any operation, the reproduction unit 134 sequentially displays video data along the moving path 60, which is the recommended field-of-view metadata.

Here, in a case where the user performs an operation of changing the line of sight at a branch point 62, reproduction of the omnidirectional content 10 is switched from passive viewing (viewing along the moving path 60) to active viewing. For example, it is assumed that the user moves the line of sight as indicated by a moving path 63 and views the omnidirectional content 10.

For example, a field of view (displayed on the screen) viewed by the user at an optional time t is expressed as VP_d(t), and a field of view based on the recommended field-of-view metadata is expressed as VP_m(t). In this case, VP_d(t)=VP_m(t) is satisfied until a time (Td) at the branch point 62. A current time, after the time Td, at the moment of shift to display of a field of view that gives priority to a user's intention is expressed as Tc, and VP_d(t)≠VP_m(t) (Td<t<Tc) holds. For example, it is assumed that the user views video data corresponding to a field-of-view area 64 at the current time Tc.

On the other hand, in a case where the omnidirectional content 10 has been displayed in accordance with the recommended field-of-view metadata, the line of sight moves along a moving path 61, and it is assumed that the user has viewed video data corresponding to a field-of-view area 65 at the predetermined time t.

For example, it is assumed that the user has viewed the video data corresponding to the field-of-view area 64, and then stops the active viewing and switches to passive viewing on the basis of the recommended field-of-view information. In this case, the field-of-view information acquisition unit 135 can specify the time t at which the video data corresponding to the field-of-view area 65 is assumed to be displayed and field-of-view information corresponding to the field-of-view area 65 on the basis of the recommended field-of-view metadata (e.g., information in which time-series information and the moving path 61 are associated with each other).

That is, the field-of-view information acquisition unit 135 can acquire, as the first field-of-view information, information for specifying the first field of view displayed on a display unit (in the example in FIG. 6, field-of-view information corresponding to the field-of-view area 64) on the basis of an active operation by the user, and also acquire, as the second field-of-view information, information for specifying the second field of view that is predicted to be displayed a predetermined time after the first field of view is displayed on the display unit (in the example in FIG. 6, field-of-view information corresponding to the field-of-view area 65) on the basis of the recommended field-of-view information.

Note that, in FIG. 6, it is assumed that the user performs an operation of returning to viewing based on the recommended field-of-view information at the time t=Tc. In a case where the image processing apparatus 100 instantaneously switches the video during one frame of the video, VP_d(Tc+1)=VP_m(Tc+1) holds, and thereafter, the relationship expressed as VP_d(t)=VP_m(t) (Tc+1<t) continues.

However, as described above, there is a possibility that instantaneous switching of the video deteriorates the user experience in the wide angle-of-view image. Thus, the generation unit 136 generates transition field-of-view information, which is information indicating the transition in field of view from the first field of view to the second field of view on the basis of the first field-of-view information and the second field-of-view information.

The generation unit 136 generates transition field-of-view information in a case where a moving path of the line of sight different from the recommended field-of-view information due to an active operation by the user has been detected, for example.

As an example, the generation unit 136 generates the transition field-of-view information including the moving path of the line of sight from the first field of view to the second field of view on the basis of the first field-of-view information and the recommended field-of-view information.

For example, in a case where the field-of-view information acquisition unit 135 has acquired a moving path of the line of sight of the user until the first field-of-view information is acquired, the generation unit 136 generates the transition field-of-view information including the moving path of the line of sight from the first field of view to the second field of view on the basis of the moving path of the line of sight of the user until the first field-of-view information is acquired and the recommended field-of-view information.

Furthermore, in a case where the field-of-view information acquisition unit 135 has acquired a speed and an acceleration in the movement of the line of sight of the user until the first field-of-view information is acquired, the generation unit 136 generates the transition field-of-view information including the moving path of the line of sight from the first field of view to the second field of view on the basis of the speed and the acceleration in the movement of the line of sight of the user until the first field-of-view information is acquired and a speed and an acceleration in the movement of the line of sight registered as the recommended field-of-view information.

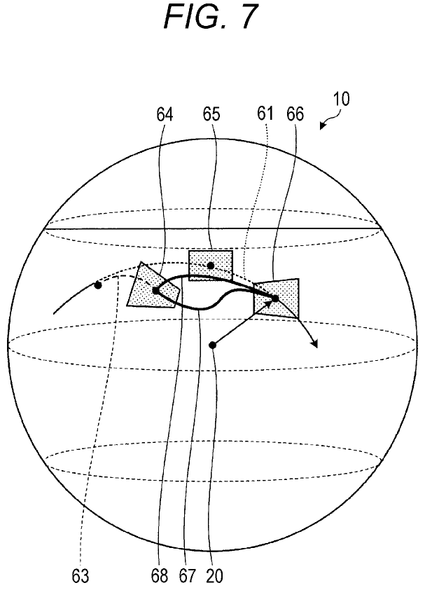

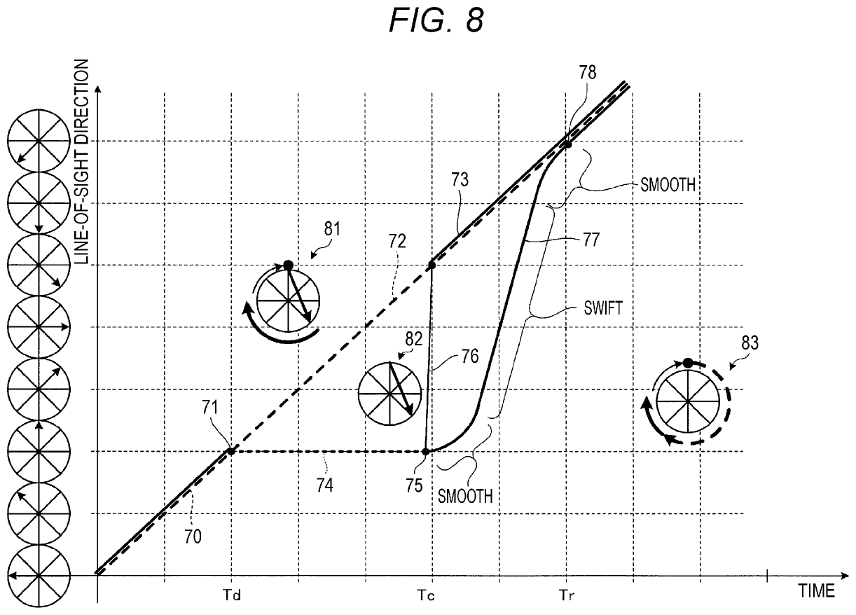

The above point will be described with reference to FIGS. 7 and 8. FIG. 7 is a diagram for illustrating generation processing according to the first embodiment.

In the example illustrated in FIG. 7, it is assumed that the line of sight is switched to the recommended field-of-view information at the current time Tc when the user views the video corresponding to the field-of-view area 64. In this case, the generation unit 136 generates optimum transition field-of-view information in consideration of the movement of the line of sight detected at t=Tc (e.g., movement of the line of sight of the user indicated by the moving path 63), the moving path 61 in the recommended field-of-view metadata, the speed and the acceleration in each moving path, and the like. Specifically, the generation unit 136 generates the transition field-of-view information as a moving path from the current field of view of the user to the field of view in accordance with the recommended field-of-view information, arrival at which is at a time Tr. Note that the transition field-of-view information is a moving path, and is also field-of-view information for specifying a line-of-sight position (field of view) regarding a position, in a wide angle-of-view image, to be displayed.

As an example, in a case where the user has fixed the line of sight and has been gazing at the video at the time t=Tc, there is no limitation on an initial movement direction of a line-of-sight movement, and thus, the generation unit 136 generates a path that allows for arrival in the shortest time at a field of view VP_m(Tr) in accordance with the recommended field-of-view information. For example, the generation unit 136 generates a moving path 68 illustrated in FIG. 7 as the transition field-of-view information.

On the other hand, in a case where the user is in the middle of moving the line of sight at the time t=Tc (in a case where a speed and an acceleration of the line of sight are detected along the moving path 63), the generation unit 136 may generate a path in which the initial movement direction of the line-of-sight movement is in conformity with the moving path 63, and then the line-of-sight movement smoothly joins the recommended field-of-view information. Specifically, the generation unit 136 generates a moving path 67 illustrated in FIG. 7 as the transition field-of-view information. In this case, in a case where VP_d(t) still catches up with VP_m(Tr) even at the time t=Tr, the generation unit 136 may generate transition field-of-view information in which the line of sight moves in an orientation that is smoothly connected to the moving direction of VP_m(Tr)>VP_d(Tr+1). Then, the generation unit 136 displays a field-of-view area 66, which is a joining destination to the recommended field-of-view information, while sequentially displaying the video from the field-of-view area 64 along the moving path 67, which is the generated transition field-of-view information. This allows the generation unit 136 to switch the line of sight without providing a feeling of strangeness to the user.

The generation processing executed by the generation unit 136 will be further described with reference to FIG. 8 conceptually illustrating a speed and an acceleration of a line-of-sight movement. FIG. 8 is a diagram conceptually illustrating transition field-of-view information according to the first embodiment.

FIG. 8 illustrates a relationship between a time axis and an axis indicating a movement in a line-of-sight direction by an angle corresponding to the omnidirectional content 10. Specifically, FIG. 8 illustrates a relationship between the time and the orientation of the line of sight in a case where, in viewing in accordance with recommended field-of-view information, it is assumed that the line of sight moves horizontally clockwise at a constant speed on a central plane of a sphere.

A dotted line 70 indicates a speed relationship in the line-of-sight direction in a case of viewing in accordance with the recommended field-of-view information. As illustrated in FIG. 8, the dotted line 70 indicates that the line of sight moves horizontally clockwise at a constant speed along time.

Here, the time of arrival at a branch point 71 is expressed as a time Td. A dotted line 72 indicates the speed relationship in the line-of-sight direction in a case where the viewing in accordance with the recommended field-of-view information is assumed to be continued. Note that a sphere 81 schematically illustrates a situation in which the line of sight has moved to the front at a constant speed in accordance with the recommended field-of-view information.

On the other hand, a dotted line 74 indicates that the viewpoint has stopped at an angle due to an active motion of a user. For example, the dotted line 74 indicates that the user has stopped moving the line-of-sight at the time Td and has gazed in a particular direction (the front in the example in FIG. 8) for a certain period of time.

Thereafter, when the user tries to instantaneously return the display of the omnidirectional content 10 to the field of view in accordance with the recommended field-of-view information at the time Tc, the generation unit 136 generates transition field-of-view information 76 that directly joins a line 73 from a branch point 75. In this case, the video is instantaneously switched (e.g., during one frame), and there is a possibility that this deteriorates the user experience. Note that a sphere 82 schematically illustrates a situation in which the display is switched from the front line-of-sight direction to a line-of-sight direction indicated by time-series recommended field-of-view information.

In order to avoid a sudden switching as described above, the generation unit 136 optionally sets a time Tr, which is a predetermined time after the time Tc, and generates transition field-of-view information that joins the recommended field-of-view information at the time Tr.

That is, the generation unit 136 generates transition field-of-view information 77 for smoothly switching the line of sight over the time Tc<t<Tr. At this time, a speed and an acceleration of the transition field-of-view information 77 are indicated by an inclination of the transition field-of-view information 77 illustrated in FIG. 8. That is, the inclination of the transition field-of-view information 77 in FIG. 8 indicates the speed, and the change in the inclination of the transition field-of-view information 77 indicates the acceleration. Note that a sphere 83 schematically illustrates a situation in which display is smoothly switched from the front line-of-sight direction to a line-of-sight direction indicated by the time-series recommended field-of-view information.

In this case, as illustrated in FIG. 8, instead of setting a fixed inclination (speed) for the transition field-of-view information 77, the generation unit 136 may provide a portion where the line of sight smoothly moves and a portion where the line of sight swiftly moves. For example, the portion where the line of sight smoothly moves indicates a portion where the movement of the line of sight (in other words, a rotational speed in the sphere) is slower than that of the recommended field-of-view information. Furthermore, the portion where the line of sight swiftly moves indicates a portion where the movement of the line of sight is faster than that of the recommended field-of-view information.

The generation unit 136 may calculate optimum values for the speed and the acceleration of the transition field-of-view information on the basis of a wide variety of elements. For example, the generation unit 136 may calculate the speed and the acceleration of the transition field-of-view information on the basis of a predetermined ratio with respect to a speed set in the recommended field-of-view information. Furthermore, the generation unit 136 may receive, from an administrator or a user, registration of a speed and an acceleration assumed to be felt to be appropriate by a human body, and calculate a speed and an acceleration of the transition field-of-view information on the basis of the received values. Note that the speed and the acceleration according to the present disclosure may be a linear velocity at which a center point of a field of view passing on a spherical surface moves, or may be an angular velocity at which a user's line-of-sight direction is rotated as viewed from the center point of a sphere.

As described above, the generation unit 136 can generate the transition field-of-view information in which a speed higher than the speed set in the recommended field-of-view information is set. This allows the generation unit 136 to swiftly return to the recommended field-of-view information from an active operation by the user, and thus swiftly return to the display in accordance with an intention of the content creator even in a case where the line-of-sight has been switched along the way.

For example, the generation unit 136 generates transition field-of-view information that follows a line-of-sight path through which the recommended field of view should have originally passed during a period from the time Td at which the line-of-sight movement has been temporarily stopped to the time Tr at which he line-of-sight movement catches up with the recommended field-of-view information VP_m(t). At this time, the generation unit 136 generates transition field-of-view information in which the line-of-sight movement is faster than that of the recommended field-of-view information. This allows the generation unit 136 to cause the line of sight that has deviated from the recommended field of view along the way to catch up with the moving path indicated by the recommended field-of-view information over a predetermined time.

In this case, the user has a viewing experience as if the user were viewing the video while skipping sample by sample (in other words, as if the line of sight were moving at double speed), but this does not involve abrupt switching of the line of sight and does not ruin user experience. Furthermore, the generation unit 136 is only required to generate information in which the speed is changed as the transition field-of-view information, and can omit the processing of calculating the moving path. This mitigates a processing load.

Note that, in a case where recommended field-of-view information that changes the line-of-sight direction and the speed from moment to moment is set for the omnidirectional content 10 instead of smooth recommended field-of-view information as illustrated in FIG. 8 being registered, the generation unit 136 may generate the transition field-of-view information by a technique different from that described above. For example, the generation unit 136 may newly generate transition field-of-view information including a moving path that does not deteriorate user experience in accordance with a current field of view (first field of view), a field of view at a destination of a transition (second field of view), and a situation of the recommended field-of-view information.

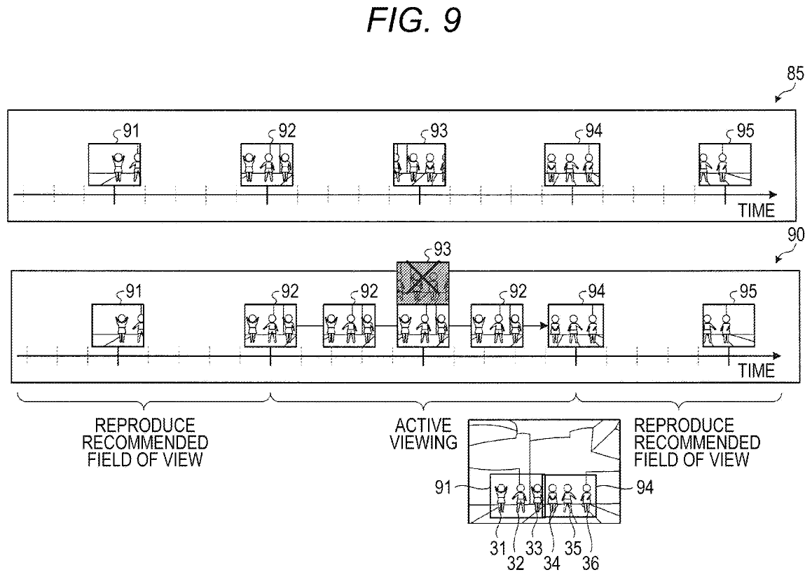

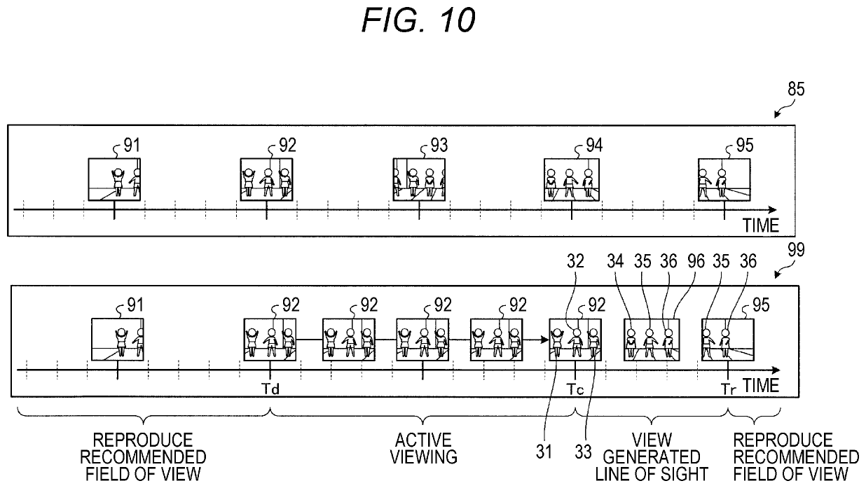

Here, an example of using the transition field-of-view information in actual video display will be described with reference to FIGS. 9 and 10. FIG. 9 is a diagram (1) illustrating an example of video display according to the first embodiment. FIG. 9 illustrates an example of video display in a case where transition field-of-view information is not generated.

As in FIG. 4, FIG. 9 illustrates an example in which a user views a video including the objects 31 to 36. For example, in a case of viewing in accordance with the recommended field-of-view information, the user views videos 91 to 95 included in a video set 85 in chronological order.

On the other hand, in a case where the user performs active viewing, as shown in a video set 90, for example, the user views videos in which the video 93 is excluded from the videos 91 to 95 in chronological order. In this case, since switching from the video 92 to the video 94 is performed in one frame, it is difficult for the user to recognize that the line of sight has moved on the basis of the feeling during viewing. That is, there is a possibility that the user does not know whether or not what the user is viewing has shifted to the recommended field-of-view information, and the viewing experience is ruined.

In order to avoid such a situation, the generation unit 136 generates transition field-of-view information and allows the user to view a video displayed in accordance with the transition field-of-view information, thereby providing video display that does not give the user a feeling of strangeness. This point will be described with reference to FIG. 10. FIG. 10 is a diagram (2) illustrating an example of video display according to the first embodiment. FIG. 10 illustrates an example of video display in a case where transition field-of-view information is generated, in which videos are similar to those illustrated in FIG. 9.

In the example illustrated in FIG. 10, for example, as indicated by a video set 99, the user views videos in chronological order in which a video 96 displayed on the basis of the transition field-of-view information is included in a movement from the video 91 to the video 95. That is, after viewing the video 92 at the time Tc, the user views not the video 94 to which the video has been instantaneously switched but the video 96 corresponding to field-of-view information that fills a space between the video 92 and the video 94, and then views the video 95. This allows the user to view not a video to which the video that the user has been gazing has been instantaneously switched but a video obtained after a smooth transition in chronological order, and thus the user can view the videos without having a feeling of strangeness.

Meanwhile, in a situation where two or more pieces of different recommended field-of-view information are registered in the omnidirectional content 10, there is a possibility that, while videos are being displayed in accordance with a certain recommended field of view, switching to another recommended field of view is performed by a user operation. In this case as well, the generation unit 136 may apply, for example, the processing illustrated in FIGS. 7 and 8 to generate transition field-of-view information so that switching between recommended fields of view is performed smoothly. That is, the transition field-of-view information can be applied not only to switching between an active operation by the user and recommended field-of-view information, but also to a variety of types of switching of the line of sight.

Returning to FIG. 5, the description will be continued. The output unit 140 outputs various signals. For example, the output unit 140 is a display unit that displays an image in the image processing apparatus 100, and is constituted by, for example, an organic electro-luminescence (EL) display, a liquid crystal display, or the like. Furthermore, in a case where the wide angle-of-view image contains audio data, the output unit 140 outputs sounds on the basis of the audio data.

[1-3. Procedure of Image Processing According to First Embodiment]

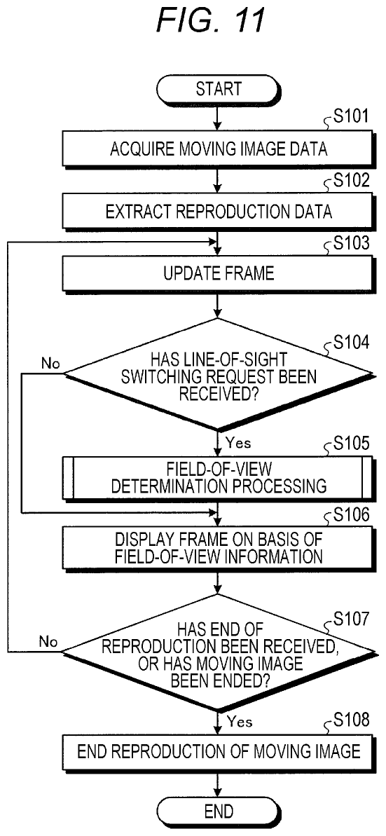

Next, a procedure of image processing according to the first embodiment will be described with reference to FIGS. 11 to 13. FIG. 11 is a flowchart (1) illustrating a flow of processing according to the first embodiment.

As illustrated in FIG. 11, the image processing apparatus 100 acquires moving image data related to a wide angle-of-view image (step S101). Then, the image processing apparatus 100 extracts reproduction data from the acquired moving image data (step S102).

The image processing apparatus 100 updates a frame to be reproduced next (step S103). At this time, the image processing apparatus 100 determines whether or not a line-of-sight switching request has been received (step S104).

If a line-of-sight switching request has been received (Yes in step S104), the image processing apparatus 100 performs field-of-view determination processing for determining field-of-view information to be displayed (step S105). On the other hand, if a line-of-sight switching request has not been received (No in step S104), the image processing apparatus 100 displays a frame (video) on the basis of the field-of-view information (e.g., field-of-view information determined on the basis of the recommended field-of-view metadata) continued from the previous frame (step S106).

Thereafter, the image processing apparatus 100 determines whether or not an end of reproduction has been received, or whether or not the moving image has ended. If an end of reproduction has not been received, or if the moving image has not been ended (No in step S107), the image processing apparatus 100 continues the processing of updating the next frame (step S103). If an end of reproduction has been received, or if the moving image has ended (Yes in step S107), the image processing apparatus 100 the image processing apparatus 100 ends the reproduction of the moving image (step S108).

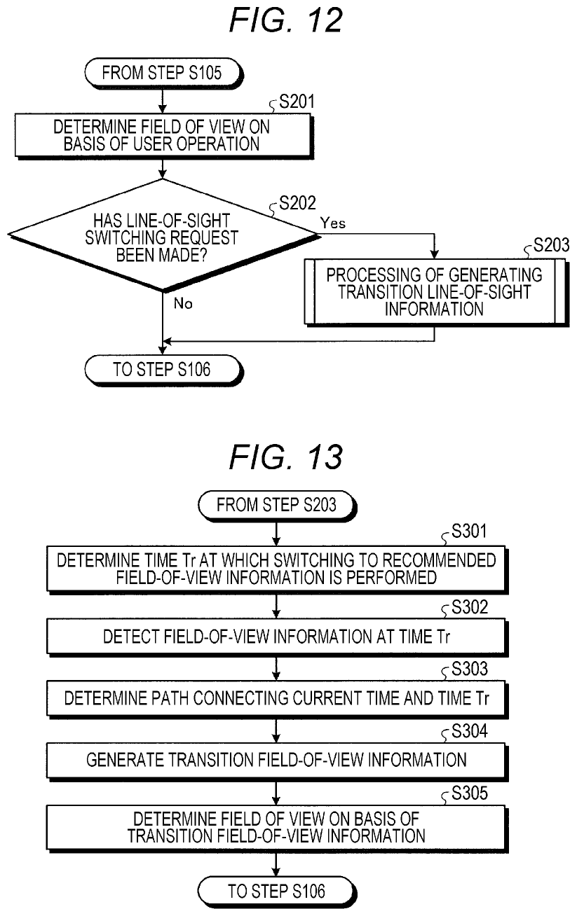

Next, a detailed procedure of the field-of-view determination processing will be described with reference to FIG. 12. FIG. 12 is a flowchart (2) illustrating a flow of processing according to the first embodiment.

As illustrated in FIG. 12, the image processing apparatus 100 determines a field of view in the wide angle-of-view image on the basis of a user operation (step S201). Note that the user operation in this case includes both an operation by which the user intends to perform active viewing and an operation by which the user demands switching to passive viewing.

Then, the image processing apparatus 100 determines whether or not a line-of-sight switching request has been made by the user operation (step S202). If a line-of-sight switching request has been made (Yes in step S202), the image processing apparatus 100 executes processing of generating transition field-of-view information (step S203). On the other hand, if a line-of-sight switching request has not been made (No in step S202), the image processing apparatus 100 executes processing of displaying a frame on the basis of a field of view (more specifically, field-of-view information for specifying the field of view) determined on the basis of the user operation (step S106).

Next, the detailed procedure of the field-of-view determination processing will be described with reference to FIG. 13. FIG. 13 is a flowchart (3) illustrating a flow of processing according to the first embodiment.

As illustrated in FIG. 13, the image processing apparatus 100 determines the time Tr at which switching to the recommended field-of-view information is performed (step S301). Next, the image processing apparatus 100 detects field-of-view information (second field-of-view information) at the time Tr, and acquires information regarding the second field-of-view information (step S302).

Then, the image processing apparatus 100 determines a path (that is, a moving path of the line of sight) connecting the current time and the time Tr on the basis of first field-of-view information and the second field-of-view information (step S303). On the basis of the determined information, the image processing apparatus 100 generates transition field-of-view information (step S304). Next, the image processing apparatus 100 determines a field of view of a frame to be displayed at the present time on the basis of the generated transition field-of-view information (step S305), and executes processing of displaying the frame (step S106).

[1-4. Modified Examples of First Embodiment]

The image processing according to the first embodiment described above may be accompanied by a variety of modifications. Hereinafter, modified examples of the first embodiment will be described.

Besides “recommended field of viewport” in a prior art document, a recommended field of view (ROI) includes, for example, a recommended field of view based on a technology called “initial viewing orientation”. The “initial viewing orientation” is a mechanism for resetting a field of view at an optional timing. In a case where the field of view is reset at an optional timing, discontinuity of the line of sight is likely to occur. Thus, even in a case where this technology is used, the image processing apparatus 100 can use the above-described transition field-of-view information to achieve smooth screen display.

The first embodiment shows an example in which a user is located at the center of the omnidirectional content 10 (so-called 3 degree of freedom (DoF)). However, the image processing according to the present disclosure is also applicable to a case where the user is not located at the center of the omnidirectional content 10 (so-called 3DoF+). That is, the field-of-view information acquisition unit 135 may acquire, as the first field-of-view information, field-of-view information corresponding to an area in which the user views the omnidirectional content 10 from a point other than the center of the omnidirectional content 10.

In this case, in a case where an amount of discrepancy in the display angle of view or the viewing position differs at the time Tc and the time Tr, the image processing apparatus 100 can smoothly connect the values by gradually changing the values from the time Tc to the time Tr. Furthermore, the image processing apparatus 100 can also achieve smooth movement of the viewing position by changing viewing position coordinates in chronological order in parallel with the line-of-sight direction, the viewing angle, or the like on the basis of dynamic information of the viewpoint position (user position). Note that, in a case where the viewpoint position is deviated from the center on the basis of an intention of the user, the image processing apparatus 100 can acquire a coordinate position indicating the deviated position, and execute the image processing described above on the basis of the acquired information.

Note that, in order that the field-of-view metadata defined in the current MPEG-I OMAF can be applied also to 3DoF+ viewing, an extension as shown in the following Math. 1, for example, is possible. For example, ViewingPosStruct indicating viewpoint position information for reproduction of a recommended field of view is newly defined, and converted to a signal in SphereRegionSample, which is a sample of the ROI defined in OMAF ed.1.

[Math. 1]

```
aligned(8) ViewingPosStrucut( ) {
  signed int(32) pos_x; // viewpoint position x coordinate
  signed int(32) pos_y; // viewpoint position y coordinate
  sighed int(32) pos_z; // viewpoint position z coordinate
}
aligned(8) SphereRegionStruct(range_inclnded_flag) {
  signed int(32) centre_azimuth;
  signed int(32) centre_elevation;
  signed int(32) centre_tilt;
  if (range_included_flag) {
    unsigned int(32) azimuth_range;
    unsigned int(32) elevation_range;
  }
  unsigned int(1) interpolate;
  bit(7) reserved = 0;
}
aligned(8) SphereRegionSample( ) {
  for (i = 0; i < num_regions; i + +) {
    SphereRegionStruct(dynamic_range_flag);
    if (dynamic_pos_flag == 1)
      ViewingPosStruct( );
  }
}
```

Moreover, information indicating whether or not the viewpoint position dynamically changes is converted to a signal in RvcpInfoBox. In a case where the viewpoint position does not dynamically change, a static viewpoint position is converted to a signal in RvcpInfoBox. In a case where the viewpoint position does not dynamically change, this has an effect of reducing the information amount of the SphereRegionSample described above. Furthermore, for example, as shown in the following Math. 2, the conversion to a signal may be performed in another box.

[Math. 2]

```
class RcvpSampleEntry( ) extends SphereRegionSampleEntry(‘rcvp’) {
  RcvpInfoBox( ); // mandatory
}
class RcvpInfoBox exends FullBox(‘rvif’, 1, 0) {
  unsigned int(8) viewport_type;
  string viewport_description;
  if (version == 1) {
    bit(7).reserved = 0;
    unsigned int(1) dynamic_pos_flag;
    if (dynamic_pos_flag == 0) {
      signed int(32) static_pos_x; // viewpoint position x coordinate
      signed int(32) static_pos_y; // viewpoint position y coordinate
      signed int(32) static_pos_z; // viewpoint position z coordinate
    }
  }
}
class SphereRegionSampleEntry(type)extends MetaDataSampleEntry(type)
{
  SphereRegionConfigBox( ); // mandatory
  Box[ ] other_boxes; // optional
}
class SphereRegionConfigBox extends FullBox(‘rosc’, 0, 0) {
  unsigned int(8) shape_type;
  bit(7) reserved = 0;
  unsigned int(1) dynamic_range_flag;
  if (dynamic_range_flag == 0) {
    unsigned int(32) static_azimuth_range;
    unsigned int(32) static_elevation_range;
  }
  unsigned int(8) num_regions;
}
```

In a case of field-of-view data with an extension as described above, it is also possible to achieve smooth movement of the viewing position by changing the viewing position coordinates (pos x, pos y, pos z) in chronological order in parallel with the line-of-sight direction, the viewing angle, or the like. In a case where there is no extension, coordinates that are held locally by a client (the image processing apparatus 100 in the embodiment) and have been shifted in accordance with an intention of a viewer (user) can be used as they are.

The first embodiment described above is based on an assumption that the image processing apparatus 100 has acquired moving image data such as the omnidirectional content 10. In this case, a correspondence between the moving image data and recommended field-of-view metadata embedded in the moving image data is not lost. However, in a case where, for example, the moving image data is streamed, there is a possibility that supply of the recommended field-of-view metadata is temporarily interrupted for some reason. For example, in a case where a packet is lost in a transmission path at the time of delivery of the moving image data or an authoring trouble occurs at the time of live stream, there is a possibility that the supply of the recommended field-of-view metadata is temporarily interrupted. Furthermore, in some cases, for the purpose of securing a band of the transmission path on the side of the image processing apparatus 100, it is conceivable to give priority to videos and sounds and intentionally drop acquisition of the recommended field-of-view metadata.

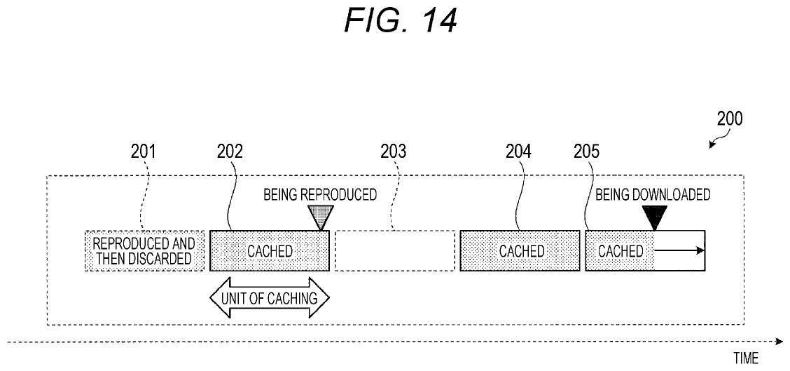

FIG. 14 conceptually illustrates a situation in which data is missing. FIG. 14 is a diagram conceptually illustrating missing of recommended field-of-view metadata. The example illustrated in FIG. 14 shows a situation in which, as for data 201 in moving image data 200, reproduction has already ended and the data has been discarded. Furthermore, in the situation indicated, data 202 has been cached and is being reproduced at the present time. Furthermore, in the situation indicated, data 203 is missing for some reason. Furthermore, in the situation indicated, data 204 has been cached. Furthermore, in the situation indicated, data 205 is being downloaded, and is in the middle of being cached. Note that the unit of caching is defined by, for example, a segment of MPEG DASH delivery.

In a case where recommended field-of-view metadata is missing, the image processing apparatus 100 performs processing to prevent the viewing experience from being ruined by suitably covering the discontinuity of the field of view before and after the missing.

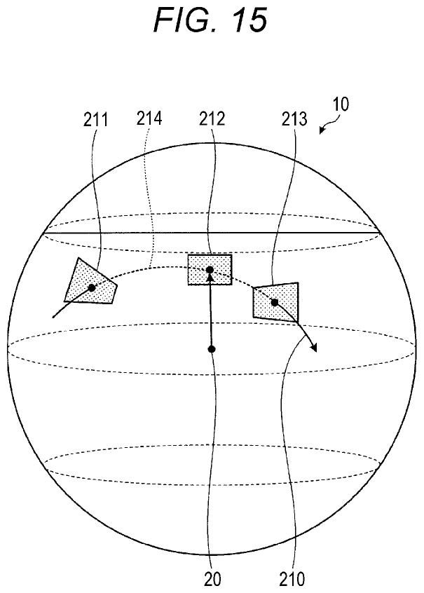

This point will be described with reference to FIG. 15. FIG. 15 is a diagram (1) illustrating an example of image processing according to a modified example of the first embodiment. For example, in the omnidirectional content 10 illustrated in FIG. 15, it is assumed that recommended field-of-view metadata between a field-of-view area 211 and a field-of-view area 213 is missing.

In this case, the image processing apparatus 100 generates, as transition field-of-view information, field-of-view data of a period of time that is missing on the basis of the recommended field-of-view metadata at a time after the missing (e.g., the data 204 or the data 205 illustrated in FIG. 14). For example, the image processing apparatus 100 generates a moving path 214 illustrated in FIG. 15 as the transition field-of-view information on the basis of the preceding and subsequent recommended field-of-view metadata.

Then, the image processing apparatus 100 connects the generated moving path 214 and a moving path 210, which is the recommended field-of-view metadata that has been cached after the missing. This allows the image processing apparatus 100 to also reproduce, without any problem, a field-of-view area 212 and the like in the period of time in which the recommended field-of-view metadata is missing. Note that, in the case of FIG. 15, the image processing apparatus 100 can perform processing similar to that in the first embodiment, for example, by regarding the time t immediately before the missing as the time Td at the branch point shown in the first embodiment or the time Tc, which is the time when the user has actively changed the viewpoint, and regarding a starting time of the cached data after the missing as the time Tr.

Note that there is a possibility that the recommended field-of-view metadata after the missing cannot be acquired. In this case, for example, the image processing apparatus 100 may continue the viewing while fixing the field of view to a state immediately before the recommended field-of-view metadata has been interrupted, and wait until it becomes possible to acquire again the recommended field-of-view metadata. In other words, the image processing apparatus 100 regards the situation in which the data is missing as similar to a “situation in which the user has actively stopped the line-of-sight movement”. Thereafter, the image processing apparatus 100 generates the transition field-of-view information that returns to the recommended field-of-view metadata by regarding a time at which VP_m(t) is interrupted as the time Td and regarding a time at which it becomes possible to acquire again the data as the time Tc. This allows the image processing apparatus 100 to provide a user with video display that does not give a feeling of strangeness even in a case where data is missing.

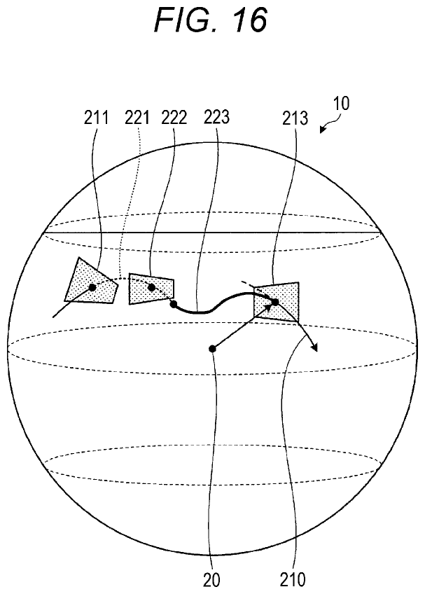

Furthermore, the image processing apparatus 100 may perform processing of predicting a path of a user's line of sight when data is missing. This point will be described with reference to FIG. 16. FIG. 16 is a diagram (2) illustrating an example of image processing according to a modified example of the first embodiment.

For example, in the omnidirectional content 10 illustrated in FIG. 16, it is assumed that recommended field-of-view metadata between the field-of-view area 211 and the field-of-view area 213 is missing. Furthermore, in the example in FIG. 16, it is assumed that a user has moved the line of sight before the missing of the data and has been viewing a field-of-view area 222. In this case, the image processing apparatus 100 generates, as the transition field-of-view information, a moving path 223, which is a predicted path of the user's line of sight, on the basis of a moving path 221 in the past (t<Td) of the user's line of sight. For example, the image processing apparatus 100 calculates the moving path 223 on the basis of the inclination, speed, and the like of the moving path 221. As an example, in a case where the moving path 221 is a movement with a horizontal constant speed, the image processing apparatus 100 calculates the moving path 223 on the assumption that the movement will be continued. Furthermore, the image processing apparatus 100 may derive a line of sight to be tracked by using image analysis or the like in a case where, for example, the recommended field-of-view metadata in the past is metadata in which a particular person in the screen is tracked so as to be arranged at the center. Note that, after it has become possible again to acquire the recommended field-of-view metadata, the image processing apparatus 100 may use the transition field-of-view information to return the field of view at the present time based on a predicted line-of-sight movement to the recommended field-of-view metadata (the moving path 210 illustrated in FIG. 16).

### 2. Second Embodiment

Next, a second embodiment will be described. In the processing described in the first embodiment, a smooth transition of a screen display is achieved by the image processing apparatus 100 generating a moving path between a first field of view and a second field of view. In the second embodiment, a smoother transition of the screen display is achieved by an image processing apparatus 100 further generating a complementary image on the basis of transition field-of-view information.

Specifically, the image processing apparatus 100 generates, on the basis of the transition field-of-view information, a complementary image, which is an image for complementing display in a moving path of the line of sight from the first field of view to the second field of view. For example, the image processing apparatus 100 generates the complementary image in a case where a frame rate of image drawing processing by a display unit (output unit 140) is higher than a frame rate of a video corresponding to a wide angle-of-view image.

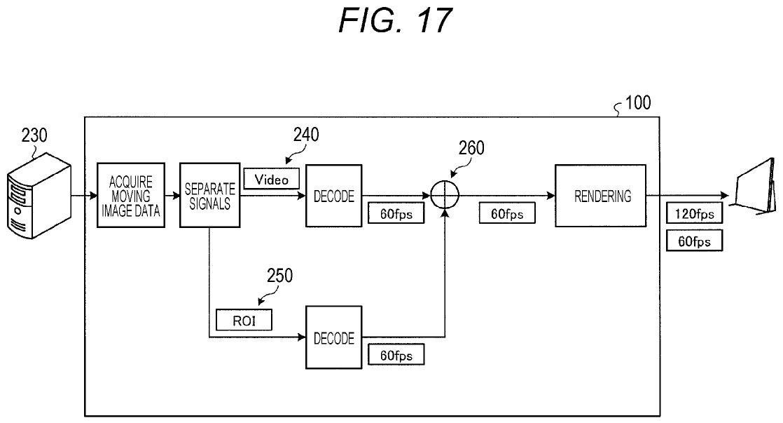

This point will be described with reference to FIGS. 17 to 19. First, processing in a case where the image processing apparatus 100 does not execute image processing according to the second embodiment will be described with reference to FIG. 17. FIG. 17 is a diagram illustrating an example of processing of generating a complementary image.

Note that, in the example in FIG. 17, it is assumed that a drawing frame rate (e.g., 120 fps) of a display device (that is, the image processing apparatus 100) is higher than a frame rate (e.g., 60 fps) of a wide angle-of-view image.

As illustrated in FIG. 17, the image processing apparatus 100 acquires wide angle-of-view image data from an external data server 230. Thereafter, the image processing apparatus 100 separates signals of the wide angle-of-view image data into moving image data 240 containing moving images and sounds and recommended field-of-view metadata 250.

Thereafter, the image processing apparatus 100 decodes both pieces of data and combines the signals by a combining unit 260. Then, at the time of outputting a video, the image processing apparatus 100 performs image interpolation at a high frame rate (120 fps in the example in FIG. 17) and outputs the video to the display device. Alternatively, the image processing apparatus 100 outputs the video to the display device at a low frame rate (60 fps in the example in FIG. 17), and performs image interpolation at 120 fps on the display device side to display the video.

In the processing illustrated in FIG. 17, in either case, after the wide angle-of-view image is planar-projected, that is, after the wide angle-of-view image is processed into a video obtained by cutting out only a portion to be displayed from the wide angle-of-view image, an interpolated video is generated from two chronologically preceding and subsequent videos. Such generation processing involves relatively advanced processing such as image recognition, and thus has a high load and is not necessarily excellent in accuracy in some cases.

On the other hand, the image processing according to the second embodiment generates a smooth video while mitigating the processing load by interpolating and generating the recommended field-of-view metadata itself before generation of a planar projection video.

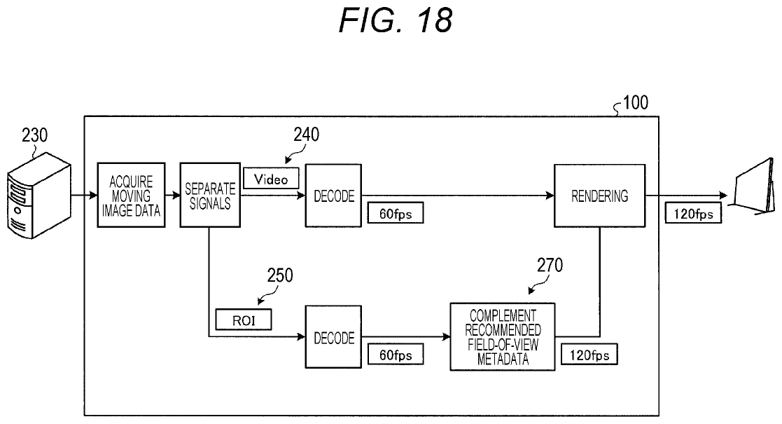

This point will be described with reference to FIG. 18. FIG. 18 is a diagram illustrating an example of the image processing according to the second embodiment.

As illustrated in FIG. 18, as compared with FIG. 17, the image processing apparatus 100 complements recommended field-of-view metadata (performs upscaling) through a processing unit 270 for generating recommended field-of-view metadata that has been separated. This allows the image processing apparatus 100 to obtain recommended field-of-view metadata corresponding to a high frame rate (120 fps in the example in FIG. 18) in accordance with the drawing. Furthermore, this also allows the image processing apparatus 100 to generate a complementary image corresponding to the recommended field-of-view metadata that has been complemented.

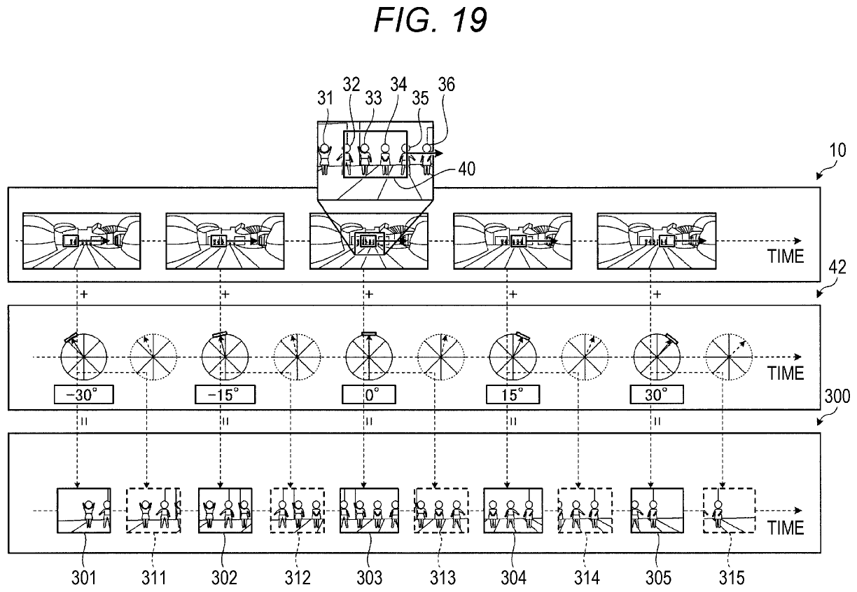

FIG. 19 illustrates an example of video display in a case where a complementary image is generated as described above. FIG. 19 is a diagram for illustrating an example of the image processing according to the second embodiment.

A video set 300 illustrated in FIG. 19 includes a complementary image corresponding to recommended field-of-view metadata that has been complemented. Specifically, in addition to a video 301, a video 302, a video 303, a video 304, and a video 305 generated at a normal frame rate (a frame rate of a wide angle-of-view image itself), the video set 300 includes a complementary image 311, a complementary image 312, a complementary image 313, a complementary image 314, and a complementary image 315 generated on the basis of the recommended field-of-view metadata that has been complemented.

Note that, in the examples in FIGS. 18 and 19, it is assumed that the frame rate of the wide angle-of-view image is lower than the frame rate of the drawing processing. Thus, the complementary image based on the recommended field-of-view metadata that has been complemented is basically generated immediately after the frame of the normal wide angle-of-view image.

According to the processing illustrated in FIGS. 18 and 19, since advanced image analysis processing is not required, the load is lower than that of generating a complementary image from an image after planar projection. Furthermore, the wide angle-of-view image can be used as it is, so that the accuracy of the generated video can be maintained high. Note that, in the example illustrated in FIG. 19, in viewing, persons and objects in the video do not move between two consecutive frames of the video, and only the field of view moves.

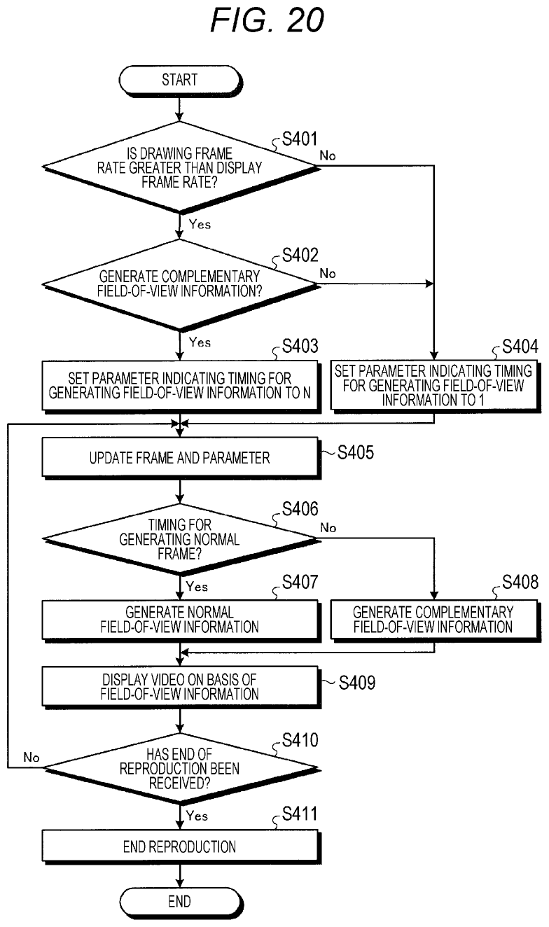

Next, a procedure of the image processing according to the second embodiment will be described with reference to FIG. 20. FIG. 20 is a flowchart illustrating a flow of processing according to the second embodiment.

As illustrated in FIG. 20, the image processing apparatus 100 determines whether or not the frame rate in the drawing processing is higher than the frame rate of the video to be displayed (step S401).

If the drawing frame rate is higher than the video frame rate (Yes in step S401), the image processing apparatus 100 determines whether or not to generate complementary field-of-view information (step S402). Note that a setting as to whether or not to generate the complementary field-of-view information may be optionally set by, for example, a provider or a user of the wide angle-of-view image.

If complementary field-of-view information is to be generated (Yes in step S402), the image processing apparatus 100 sets a parameter indicating a timing for generating field-of-view information to N (N is an optional integer) (step S403). Such a parameter is a parameter for controlling the timing for generating a field-of-view information for a complementary frame, and is determined on the basis of a ratio between the video frame rate and the drawing frame rate. For example, when the video frame rate is 60 fps and the drawing frame rate of the display device is 120 fps, the parameter is “2”. Alternatively, when the video frame rate is 60 fps and the drawing frame rate of the display device is 240 fps, the parameter is “4”. Note that, in a case where the parameter is not an integer value, conversion processing may be appropriately used.

Note that, in a case where the drawing frame rate is not higher than the video frame rate (No in step S401), or in a case where complementary field-of-view information is not to be generated (No in step S402), the image processing apparatus 100 sets the parameter indicating the timing for generating field-of-view information to 1 (step S404). This means that no complementary frame is generated, and normal rendering (rendering at a frame rate corresponding to the wide angle-of-view image) is performed.

After the parameter has been determined, the image processing apparatus 100 performs processing of updating the frame and the parameter (step S405). Then, the image processing apparatus 100 determines whether or not it is a timing for generating a normal frame (a frame corresponding to the wide angle-of-view image) on the basis of the value of the parameter (step S406). If it is the timing for generating a normal frame, the image processing apparatus 100 generates normal field-of-view information (step S407). On the other hand, if it is not the timing for generating a normal frame, the image processing apparatus 100 generates complementary field-of-view information (step S408). That is, as the value of the parameter is larger, more complementary field-of-view information is generated.

Then, the image processing apparatus 100 crops the wide angle-of-view image on the basis of the generated field-of-view information, performs rendering, and displays the video on the display unit (step S409). Thereafter, the image processing apparatus 100 determines whether or not an end of reproduction has been received (step S410). If an end of reproduction has not been received (No in step S410), the image processing apparatus 100 renders the next frame. On the other hand, if an end of reproduction has been received (Yes in step S410), the image processing apparatus 100 ends the reproduction (step S411).

### 3. Other Embodiments

The pieces of processing according to the embodiments described above may be performed in a wide variety of different modes other than the above-described embodiments.

For example, in the above-described embodiments, an example has been described in which the image processing apparatus 100, which is a reproduction device, executes the image processing according to the present disclosure. However, the image processing according to the present disclosure may be executed by, for example, an external server on a cloud. In this case, the external server transmits generated transition field-of-view information to the reproduction device, and causes reproduction processing to be executed. That is, the image processing apparatus according to the present disclosure is not necessarily a reproduction device, and may be constituted by a server, or may be constituted by a system including a server and a client (reproduction device).

Furthermore, in the above-described embodiments, an omnidirectional content has been described as an example of a wide angle-of-view image. However, the image processing according to the present disclosure can also be applied to other than omnidirectional content. For example, the image processing according to the present disclosure can also be applied to a so-called panoramic image or panoramic moving image having an area wider than an area displayable on a display. Furthermore, the image processing can also be applied to a VR image or a VR moving image (so-called half-celestial sphere content) having a range of 180 degrees. Furthermore, the wide angle-of-view image is not limited to a still image or a moving image, and may be, for example, game content created by computer graphics (CG).

Furthermore, among the pieces of processing described in the above-described embodiments, a piece of the processing described as being performed automatically can be completely or partially performed manually, or a piece of the processing described as being performed manually can be completely or partially performed automatically by a known method. In addition, the processing procedures, specific names, and information including various types of data and parameters described in the above document and illustrated in the drawings can be optionally changed unless otherwise specified. For example, the various types of information illustrated in each of the drawings are not limited to the information illustrated in the drawings.

Furthermore, each component of each device illustrated in the drawings is functionally conceptual, and is not necessarily physically configured as illustrated in the drawings. That is, a specific mode of distribution or integration of each device is not limited to the illustrated mode, and all or a part thereof can be functionally or physically distributed or integrated in an optional unit in accordance with various loads, usage conditions, and the like. For example, the field-of-view determination unit 133 and the reproduction unit 134 illustrated in FIG. 5 may be integrated.

Furthermore, the embodiments and modified examples described above can be appropriately combined within a range where inconsistency with the contents of the processing does not occur.

Furthermore, the effects described herein are merely illustrative and are not intended to be restrictive, and other effects may be obtained.

### 4. Effects of Image Processing Apparatus According to Present Disclosure

As described above, an image processing apparatus (the image processing apparatus 100 in the embodiments) according to the present disclosure includes an acquisition unit (the field-of-view information acquisition unit 135 in the embodiments) and a generation unit (the generation unit 136 in the embodiments). The acquisition unit acquires first field-of-view information, which is information for specifying a first field of view of a user in a wide angle-of-view image, and second field-of-view information, which is information for specifying a second field of view, which is a field of view at a destination of a transition from the first field of view. The generation unit generates transition field-of-view information, which is information indicating the transition in field of view from the first field of view to the second field of view on the basis of the first field-of-view information and the second field-of-view information.

In this manner, the image processing apparatus according to the present disclosure generates information indicating the transition from the first field of view to the second field of view for a smooth transition between the first field of view and the second field of view. This allows the user to avoid experiencing switching of the field of view due to an abrupt movement of the line of sight, and accept the switching of the line of sight without getting a feeling of strangeness. That is, the image processing apparatus is capable of improving user experience related to a wide angle-of-view image.

Furthermore, the acquisition unit acquires the second field-of-view information of the second field of view to which the transition from the first field of view after a predetermined time is predicted on the basis of recommended field-of-view information, which is information indicating a line-of-sight movement registered in advance in the wide angle-of-view image. This allows the image processing apparatus to accurately specify the second field-of-view information.

Furthermore, the generation unit generates the transition field-of-view information in a case where a moving path of the line of sight different from the recommended field-of-view information due to an active operation by the user has been detected. This allows the image processing apparatus to achieve a smooth image transition without causing an abrupt movement of the line of sight in a case where the line of sight is switched on the basis of a user operation.

Furthermore, the acquisition unit acquires, as the first field-of-view information, information for specifying the first field of view displayed on a display unit on the basis of an active operation by the user, and also acquires, as the second field-of-view information, information for specifying the second field of view that is predicted to be displayed a predetermined time after the first field of view is displayed on the display unit on the basis of the recommended field-of-view information. This allows the image processing apparatus to accurately specify the second field of view, to which the line of sight of the user is moved.

Furthermore, the generation unit generates the transition field-of-view information including the moving path of the line of sight from the first field of view to the second field of view on the basis of the first field-of-view information and the recommended field-of-view information. This allows the image processing apparatus to switch the line of sight along a natural moving path that does not give a feeling of strangeness.

Furthermore, the acquisition unit acquires a moving path of the line of sight of the user until the first field-of-view information is acquired. The generation unit generates the transition field-of-view information that includes a moving path of the line of sight from the first field of view to the second field of view, on the basis of the moving path of the line of sight of the user until the first field-of-view information is acquired and the recommended field-of-view information. This allows the image processing apparatus to switch the line of sight along a natural moving path that does not give a feeling of strangeness.

Furthermore, the acquisition unit acquires a speed and an acceleration in the movement of the line of sight of the user until the first field-of-view information is acquired. The generation unit generates the transition field-of-view information including the moving path of the line of sight from the first field of view to the second field of view on the basis of the speed and the acceleration in the movement of the line of sight of the user until the first field-of-view information is acquired and a speed and an acceleration in the movement of the line of sight registered as the recommended field-of-view information. This allows the image processing apparatus to achieve a smooth screen transition including not only the moving path but also the speed and the acceleration.

Furthermore, the generation unit generates the transition field-of-view information in which a speed higher than the speed set in the recommended field-of-view information is set. This allows the image processing apparatus to swiftly return the field of view to the recommended field of view even in a case where the line of sight deviates from the recommended field of view.

Furthermore, the generation unit generates, on the basis of the transition field-of-view information, a complementary image, which is an image for complementing display in a moving path of the line of sight from the first field of view to the second field of view. This allows the image processing apparatus to achieve a smooth image transition from the viewpoint of screen display in addition to the moving path.

Furthermore, the generation unit generates the complementary image in a case where a frame rate of image drawing processing by the display unit is higher than a frame rate of a video corresponding to the wide angle-of-view image. This allows the image processing apparatus to make the user experience a more natural screen transition.

Furthermore, the acquisition unit acquires, as the first field-of-view information, field-of-view information corresponding to an area in which the user views omnidirectional content from the center of the omnidirectional content. This allows the image processing apparatus to achieve a smooth screen transition in screen display for omnidirectional content.

Furthermore, the acquisition unit acquires, as the first field-of-view information, field-of-view information corresponding to an area in which the user views omnidirectional content from a point other than the center of the omnidirectional content. This allows the image processing apparatus to achieve a smooth screen transition even in a technology related to 3DoF+.

### 5. Hardware Configuration

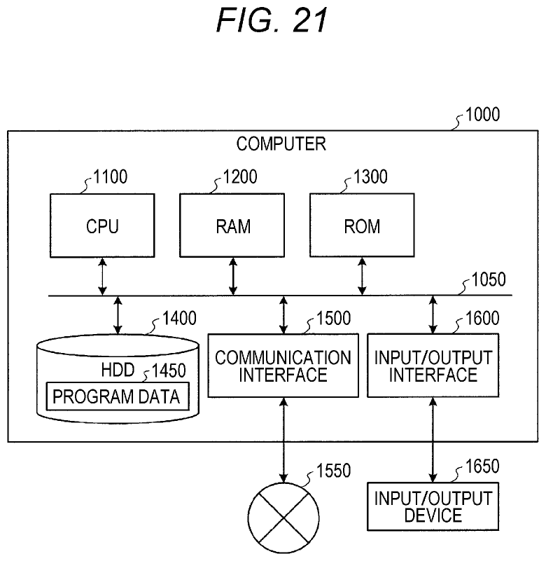

Information equipment such as the image processing apparatus 100 according to the embodiments described above is constituted by, for example, a computer 1000 having a configuration as illustrated in FIG. 21. The image processing apparatus 100 according to the first embodiment will be described below as an example. FIG. 21 is a hardware configuration diagram illustrating an example of the computer 1000 that implements the functions of the image processing apparatus 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 decompresses, in the RAM 1200, a program stored in the ROM 1300 or the HDD 1400, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records the image processing program according to the present disclosure, which is an example of a program data 1450.

The communication interface 1500 is an interface for the computer 1000 to connect to an external network 1550 (e.g., the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or a mouse via the input/output interface 1600. Furthermore, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the image processing apparatus 100 according to the first embodiment, the CPU 1100 of the computer 1000 implements a function of the control unit 130 by executing an image processing program loaded on the RAM 1200. Furthermore, the HDD 1400 stores the image processing program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also be configured as described below.

(1)

An image processing apparatus including:

an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and

a generation unit that generates transition field-of-view information, which is information indicating the transition in field of view from the first field of view to the second field of view on the basis of the first field-of-view information and the second field-of-view information.

(2)

The image processing apparatus according to (1), in which

the acquisition unit acquires the second field-of-view information of the second field of view to which the transition from the first field of view after a predetermined time is predicted on the basis of recommended field-of-view information, which is information indicating a line-of-sight movement registered in advance in the wide angle-of-view image.

(3)

The image processing apparatus according to (2), in which

the generation unit generates the transition field-of-view information in a case where a moving path of the line of sight different from the recommended field-of-view information due to an active operation by the user has been detected.

(4)

The image processing apparatus according to (3), in which

the acquisition unit acquires, as the first field-of-view information, information for specifying the first field of view displayed on a display unit on the basis of an active operation by the user, and also acquires, as the second field-of-view information, information for specifying the second field of view that is predicted to be displayed a predetermined time after the first field of view is displayed on the display unit on the basis of the recommended field-of-view information.

(5)

The image processing apparatus according to (3) or (4), in which

the generation unit generates the transition field-of-view information including the moving path of the line of sight from the first field of view to the second field of view on the basis of the first field-of-view information and the recommended field-of-view information.

(6)

The image processing apparatus according to (5), in which

the acquisition unit acquires a moving path of the line of sight of the user until the first field-of-view information is acquired; and

the generation unit generates the transition field-of-view information that includes a moving path of the line of sight from the first field of view to the second field of view, on the basis of the moving path of the line of sight of the user until the first field-of-view information is acquired and the recommended field-of-view information.

(7)

The image processing apparatus according to (6), in which

the acquisition unit acquires a speed and an acceleration in the movement of the line of sight of the user until the first field-of-view information is acquired; and

the generation unit generates the transition field-of-view information including the moving path of the line of sight from the first field of view to the second field of view on the basis of the speed and the acceleration in the movement of the line of sight of the user until the first field-of-view information is acquired and a speed and an acceleration in the movement of the line of sight registered as the recommended field-of-view information.

(8)

The image processing apparatus according to (7), in which

the generation unit generates the transition field-of-view information in which a speed higher than the speed set in the recommended field-of-view information is set.

(9)

The image processing apparatus according to any one of (2) to (7), in which

the generation unit generates, on the basis of the transition field-of-view information, a complementary image, which is an image for complementing display in a moving path of the line of sight from the first field of view to the second field of view.

(10)

The image processing apparatus according to (9), in which

the generation unit generates the complementary image in a case where a frame rate of image drawing processing by a display unit is higher than a frame rate of a video corresponding to the wide angle-of-view image.

(11)

The image processing apparatus according to any one of (1) to (10), in which

the acquisition unit acquires, as the first field-of-view information, field-of-view information corresponding to an area in which the user views omnidirectional content from the center of the omnidirectional content.

(12)

The image processing apparatus according to any one of (1) to (11), in which

the acquisition unit acquires, as the first field-of-view information, field-of-view information corresponding to an area in which the user views omnidirectional content from a point other than the center of the omnidirectional content.

(13)

An image processing method executed by a computer, the method including:

acquiring first field-of-view information, which is information for specifying a first field of view of a user in a wide angle-of-view image, and second field-of-view information, which is information for specifying a second field of view, which is a field of view at a destination of a transition from the first field of view; and

generating transition field-of-view information, which is information indicating the transition in field of view from the first field of view to the second field of view on the basis of the first field-of-view information and the second field-of-view information.

(14)

An image processing program for causing a computer to function as:

an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and

a generation unit that generates transition field-of-view information, which is information indicating the transition in field of view from the first field of view to the second field of view on the basis of the first field-of-view information and the second field-of-view information.

### REFERENCE SIGNS LIST

100 Image processing apparatus
110 Communication unit
120 Storage unit
130 Control unit
131 Image acquisition unit
132 Display control unit
133 Field-of-view determination unit
134 Reproduction unit
135 Field-of-view information acquisition unit
136 Generation unit

1. An image processing apparatus comprising:
an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and
a generation unit that generates transition field-of-view information, which is information indicating the transition in field of view from the first field of view to the second field of view on a basis of the first field-of-view information and the second field-of-view information.

2. The image processing apparatus according to claim 1, wherein
the acquisition unit acquires the second field-of-view information of the second field of view to which the transition from the first field of view after a predetermined time is predicted on a basis of recommended field-of-view information, which is information indicating a line-of-sight movement registered in advance in the wide angle-of-view image.

3. The image processing apparatus according to claim 2, wherein
the generation unit generates the transition field-of-view information in a case where a moving path of the line of sight different from the recommended field-of-view information due to an active operation by the user has been detected.

4. The image processing apparatus according to claim 3, wherein
the acquisition unit acquires, as the first field-of-view information, information for specifying the first field of view displayed on a display unit on a basis of an active operation by the user, and also acquires, as the second field-of-view information, information for specifying the second field of view that is predicted to be displayed a predetermined time after the first field of view is displayed on the display unit on a basis of the recommended field-of-view information.

5. The image processing apparatus according to claim 3, wherein
the generation unit generates the transition field-of-view information including the moving path of the line of sight from the first field of view to the second field of view on a basis of the first field-of-view information and the recommended field-of-view information.

6. The image processing apparatus according to claim 5, wherein
the acquisition unit acquires a moving path of the line of sight of the user until the first field-of-view information is acquired; and
the generation unit generates the transition field-of-view information that includes a moving path of the line of sight from the first field of view to the second field of view, on a basis of the moving path of the line of sight of the user until the first field-of-view information is acquired and the recommended field-of-view information.

7. The image processing apparatus according to claim 6, wherein
the acquisition unit acquires a speed and an acceleration in the movement of the line of sight of the user until the first field-of-view information is acquired; and
the generation unit generates the transition field-of-view information including the moving path of the line of sight from the first field of view to the second field of view on a basis of the speed and the acceleration in the movement of the line of sight of the user until the first field-of-view information is acquired and a speed and an acceleration in the movement of the line of sight registered as the recommended field-of-view information.

8. The image processing apparatus according to claim 7, wherein
the generation unit generates the transition field-of-view information in which a speed higher than the speed set in the recommended field-of-view information is set.

9. The image processing apparatus according to claim 2, wherein
the generation unit generates, on a basis of the transition field-of-view information, a complementary image, which is an image for complementing display in a moving path of the line of sight from the first field of view to the second field of view.

10. The image processing apparatus according to claim 9, wherein
the generation unit generates the complementary image in a case where a frame rate of image drawing processing by a display unit is higher than a frame rate of a video corresponding to the wide angle-of-view image.

11. The image processing apparatus according to claim 1, wherein
the acquisition unit acquires, as the first field-of-view information, field-of-view information corresponding to an area in which the user views omnidirectional content from a center of the omnidirectional content.

12. The image processing apparatus according to claim 1, wherein
the acquisition unit acquires, as the first field-of-view information, field-of-view information corresponding to an area in which the user views omnidirectional content from a point other than a center of the omnidirectional content.

13. An image processing method executed by a computer, the method comprising:
acquiring first field-of-view information, which is information for specifying a first field of view of a user in a wide angle-of-view image, and second field-of-view information, which is information for specifying a second field of view, which is a field of view at a destination of a transition from the first field of view; and
generating transition field-of-view information, which is information indicating the transition in field of view from the first field of view to the second field of view on a basis of the first field-of-view information and the second field-of-view information.

14. An image processing program for causing a computer to function as:
an acquisition unit that acquires first field-of-view information, which is information for specifying a first field of view of a user in a wide angle-of-view image, and second field-of-view information, which is information for specifying a second field of view, which is a field of view at a destination of a transition from the first field of view; and
a generation unit that generates transition field-of-view information, which is information indicating the transition in field of view from the first field of view to the second field of view on a basis of the first field-of-view information and the second field-of-view information.
